(19) United States
(12) Patent Application Publication
(10) Pub. No.: US 2009/0070773 A1
(43) Pub. Date: Mar. 12, 2009

(54) METHOD FOR EFFICIENT THREAD USAGE FOR HIERARCHICALLY STRUCTURED TASKS

(75) Inventors: Alexandre DEPOUTOVITCH, Toronto (CA); Daniel SIEROKA, Toronto (CA); Stephen POLLACK, Toronto (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: NOVELL, INC., Waltham, MA (US)

(21) Appl. No.: 12/207,648

(22) Filed: Sep. 10, 2008

(30) Foreign Application Priority Data
Sep. 10, 2007 (CA) PCT/CA2007/001588

(51) Int. Cl. G06F 9/46

(52) U.S. Cl. 718/106

(57) ABSTRACT

A system and method for dividing complex tasks into sub-tasks for the purpose of improving performance in completing the task. Sub-tasks are arranged hierarchically and if a sub-task is unable to obtain a thread for execution it is executed in the thread of the parent task. Should a thread become free it is returned to a thread pool for use by any task. Should a parent task be waiting on the completion of one or more sub-tasks, the thread it uses is returned to the thread pool for use by any other task as needed.

### BACKGROUND

In using multiple threads to complete a task the total thread number is limited by resources such as CPU availability and memory. A thread may be waiting for tasks to complete their function and as a result is not used until all dependant tasks are complete, thus wasting resources.

Thus there is a need to utilize the thread that is waiting for other tasks to improve the performance of the task. The present invention addresses this need.

### SUMMARY OF THE INVENTION

The present invention relates to a system and method for dividing complex tasks into sub-tasks for the purpose of improving performance in completing the task.

One aspect of the present invention is a method of hierarchically dividing and executing a task on a computing device comprising the steps of:

a) dividing the task into a hierarchy of parent and sub-tasks;
b) associating the parent task or a sub-task to a thread, said thread obtained from a thread pool;
c) executing multiple sub-tasks within a parent thread if no additional threads are available in said thread pool; and
d) if said parent thread is waiting for one or more sub-tasks to complete, configuring said parent task to receive an event indicating the completion of sub-tasks associated with said parent task and returning the thread of said parent task to said thread pool for reuse.

In another aspect of the present invention there is provided a method for hierarchically dividing and executing a task on a computing device comprising the steps of:
a) dividing the task into sub-tasks;
b) if a thread is available for a sub-task, utilizing said thread to execute said sub-task;
c) if a thread is not available for a sub-task running said sub-task in a parent thread;
d) if a task completes, returning said thread, associated with the task, to a thread pool for reuse; and
e) if a parent task is waiting for a sub-task to complete, configuring said parent task as waiting for an event to complete and returning the thread for said parent task to said thread pool for reuse.

In yet another aspect of the present invention there is provided a system for hierarchically dividing and executing a task on a computing device comprising;

a) a user interface configured to permit a user to enter tasks to be executed;

b) a network discovery service operatively connected to said user interface and configured to receive input from said user interface;

c) a hierarchical module within said network discovery service configured to utilize a thread for a sub-task or a parent task;

d) said hierarchical module configured to obtain a thread for executing a sub-task or a parent task from a thread pool; and

e) said hierarchical module configured to return the thread of a parent task for reuse should said parent task be in a wait state and to configure said parent task as waiting for sub-tasks to complete.

### BRIEF DESCRIPTION OF THE DRAWINGS

Embodiments are illustrated by way of example and without limitation in the figures of the accompanying drawings, in which like reference numerals indicate corresponding, analogous or similar elements, and in which:

FIG. 1 is a hierarchical diagram of a specific task structure;

FIG. 2 is a hierarchical diagram of a general task structure;

FIG. 3 is a hierarchical diagram of a thread structure;

FIGS. 4a and 4b are a flowchart of a process for the hierarchical distribution and execution of tasks; and

FIGS. 5a and 5b are a block diagram of a system utilizing an embodiment of the present invention.

### DETAILED DESCRIPTION

A complex task is modeled as a hierarchical tree of quicker, simpler tasks and executed within hierarchically organized processing threads. In a finite resource system, waiting processing threads are reused to process sub-tasks, thus increasing the overall performance efficiency.

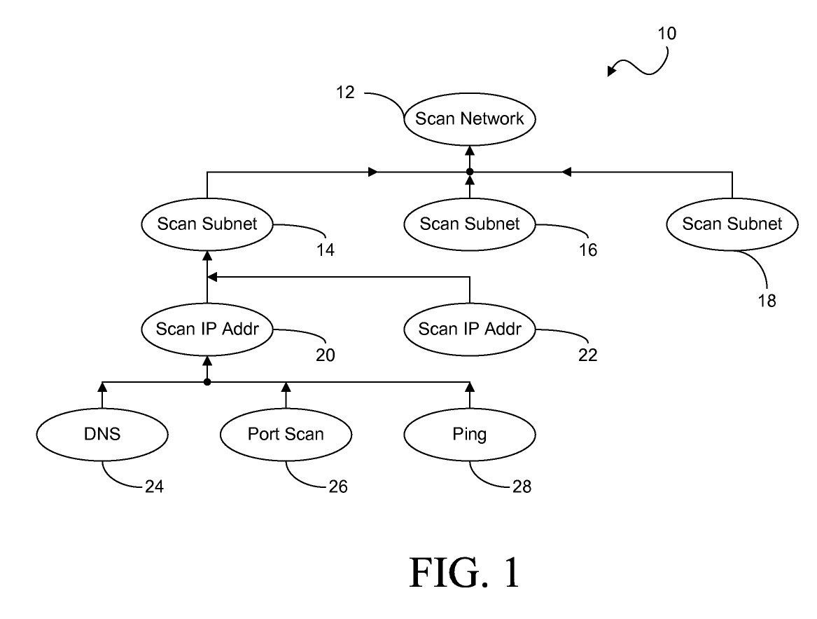

By way of example of one implementation of the invention, the large task of discovering the network devices on a network is first partitioned into the discovery of a number of sub-networks, followed by the discovery of an IP address, and finally the discovery using specific protocols and procedures, such as DNS, port scan, or ping. These discovery methods serve as examples of how the present invention may be utilized. One skilled in the art will recognize that any number of discovery means may be utilized. In this scenario each device on a network is associated with an IP address. To better illustrate this reference is now made to FIG. 1, a hierarchical diagram of a specific task structure is shown generally as 10.

Each task is run in a thread that is obtained from a thread pool. When there are no threads available in the thread pool, the task will run in the current thread rather than waiting for the next available thread. For example, the leaves in the tree, given by nodes 18, 22, 24, 26, and 28, will process the required task, while the tasks associated with branches, 12, 14, and 20, are waiting for the sub-tasks to complete in order to merge the results from each sub-task and pass the results to the parent task. Whereas the scanning of an IP address given by node 20 is performed by nodes 24, 26 and 28, the scanning of an IP address given by node 22 is done within that node. That is, the same tasks that are run in nodes 24, 26 and 28 are run in node 22. A similar situation exists for nodes 14 and 16. The tasks for node 14 are run by nodes 22, 24, 26 and 28, whereas node 16 runs all the tasks necessary to discover the subnet. When a thread becomes free, for example node 28, this thread can then be used by other nodes, for example node 22 may use the thread to perform DNS while it continues with a port scan.

Modeling the time consuming tasks as smaller, quicker tasks combined with a hierarchical processing tree results in improved performance through the efficient use of threads.

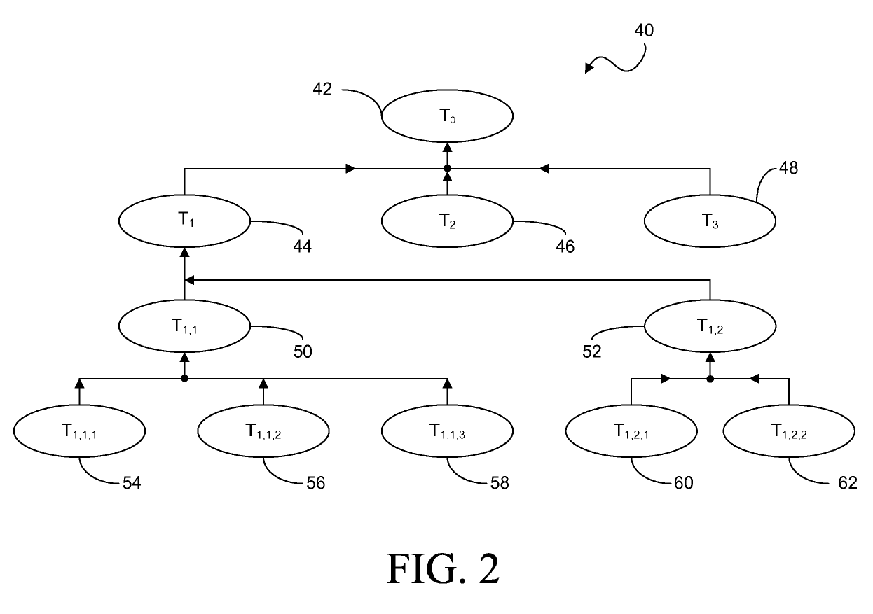

We now move from the specific example of FIG. 1 by referring to FIG. 2, a hierarchical diagram of a general task structure, which is shown generally as 40.

A complex, time consuming task is modeled as a collection of smaller tasks and organized in a hierarchy such that the completion of a task at a given hierarchical node is dependent upon the completion of the tasks for all its sub-nodes. For example, let T_{K} be a given task where K is the path to this task from the root node. For example K=1,2,2 indicates a path T₀-T₁-T_{1,2}-T_{1,2,2}. Task T₀ is modeled as tasks T₁, T₂ and T₃. Task T₁, in turn, is modeled as tasks T_{1,1} and T_{1,2}. Task T_{1,1} is modeled as tasks T_{1,1,1}, T_{1,1,2}, and T_{1,1,3}, and finally, task T_{1,2} is modeled as tasks T_{1,2,1} and T_{1,2,2}.

Thus for task T_{1,1,} to complete, tasks T_{1,1,1}, T_{1,1,2}, and T_{1,1,3} must be completed, or T_{1,1}=T_{1,1,1}+T_{1,1,2}+T_{1,1,3}. Similarly, for T₀ complete, all the sub-tasks will have to complete. The lines with arrowheads indicate notification by a sub-task that it has completed.

To aid the reader in mapping the task numbers of the above example to the feature numbers of FIG. 2 we provide the following Table 1.

TABLE 1
Mapping of Task Numbers to Feature Numbers of FIG. 2

| Task Number | Feature Number |
|---|---|
| T₀ | 42 |
| T₁ | 44 |
| T₂ | 46 |
| T₃ | 48 |
| T_{1,1} | 50 |
| T_{1,2} | 52 |
| T_{1,1,1} | 54 |
| T_{1,1,2} | 56 |
| T_{1,1,3} | 58 |
| T_{1,2,1} | 60 |
| T_{1,2,2} | 62 |

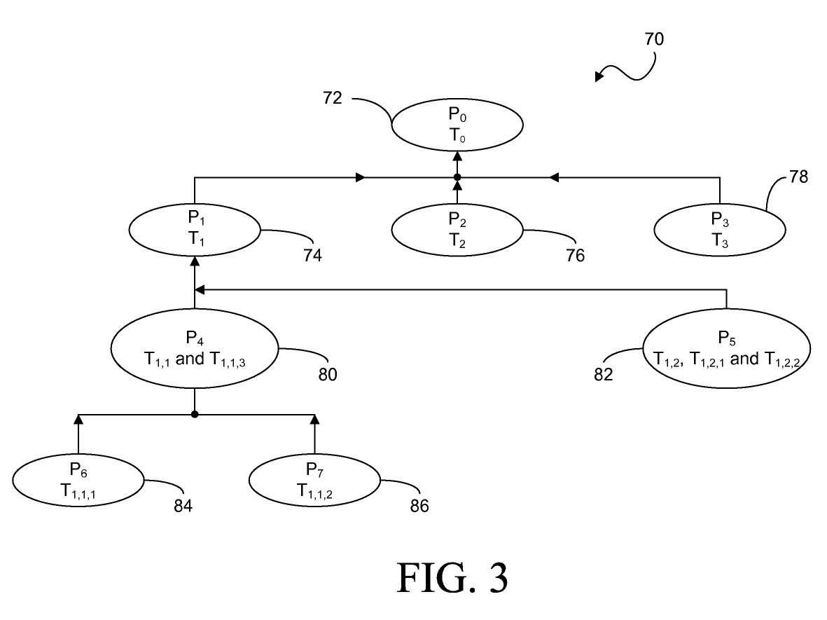

Tasks are run within threads. However, because only a finite amount of threads are available, it may not be possible to have one thread per task. FIG. 3 is a hierarchical diagram of a thread structure, shown generally as 70. FIG. 3 shows the threads P_{N} that run the given tasks.

Thread P₁ runs task T₁. The first step for T₁ is to associate its sub-tasks T_{1,1} and T_{1,2} with threads P₄ and P₅. Task T₁ is then set to wait for events from its sub-tasks. The thread P₁, is returned to the thread pool for use by other tasks. In this example, there are not enough threads to run each task, thus thread P₄ must run T_{1,1}, and T_{1,1,3} while thread P₅ must run T_{1,2}, T_{1,2,1} and T_{1,2,2}. If a thread becomes free, due to a task completing, then one of the threads running multiple tasks can use the newly freed thread to run one of its remaining tasks. For example when T_{1,2,2} completes and frees up a thread, P₇ can use this thread to run T_{1,2,2}. If a parent task is waiting for sub-tasks to complete, the thread associated with the parent task is returned to a thread pool so that the thread may be used by other tasks. The parent task is configured to wait for an event from its sub-tasks. Upon receiving the event, the parent-task will perform the necessary actions to coordinate the results of the sub-tasks.

There are many solutions that allow an event to be passed from a sub-task to the parent task. One embodiment accomplishes event passing by passing the entire parent task object to the sub-task. Once the sub-task has completed, it returns the results to the parent task. At this point, the parent task processes the data within the thread being used by the sub-task. If the parent task requires information from multiple sub-tasks, the parent task will not process the data until the final sub-task completes. That is, when a sub-task passes data back to a parent task and the parent task is waiting on other sub-tasks to complete, the parent task will store the data. When the final sub-task is complete, only then will the parent task finish processing the results. Another embodiment would associate the parent task with a running thread such that the parent task is periodically checked to determine if it has received events from the sub-tasks.

To aid the reader in mapping the thread and task numbers of the above example to the feature numbers of FIG. 3 we provide the following Table 2.

TABLE 2
Mapping of Thread and Task Numbers to Feature Numbers of FIG. 3

| Thread Number | Task Number | Feature Number |
|---|---|---|
| P₀ | T₀ | 72 |
| P₁ | T₁ | 74 |
| P₂ | T₂ | 76 |
| P₃ | T₃ | 78 |
| P₄ | T_{1,1} and T_{1,1,3} | 80 |
| P₅ | T_{1,2,} T_{1,2,1} and T_{1,2,2} | 82 |
| P₆ | T_{1,1,1} | 84 |
| P₇ | T_{1,1,2} | 86 |

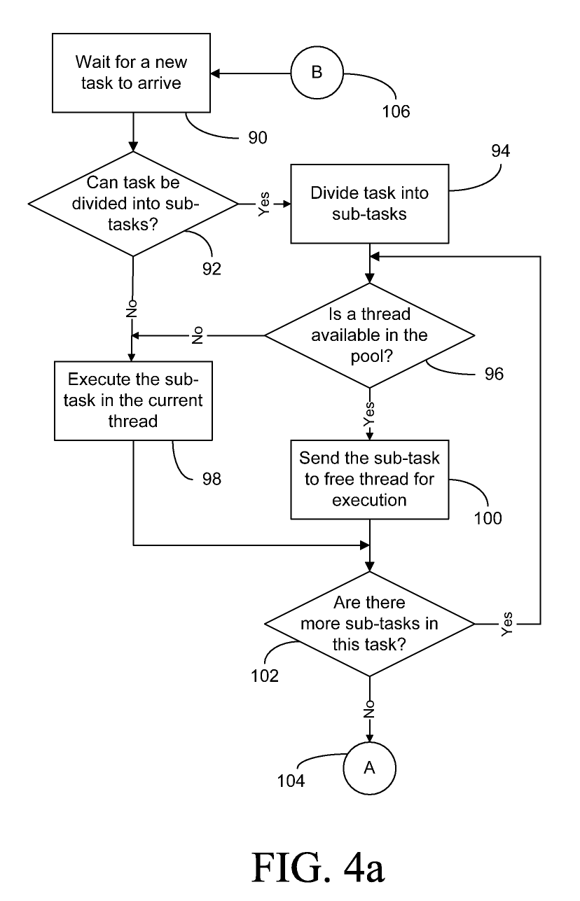

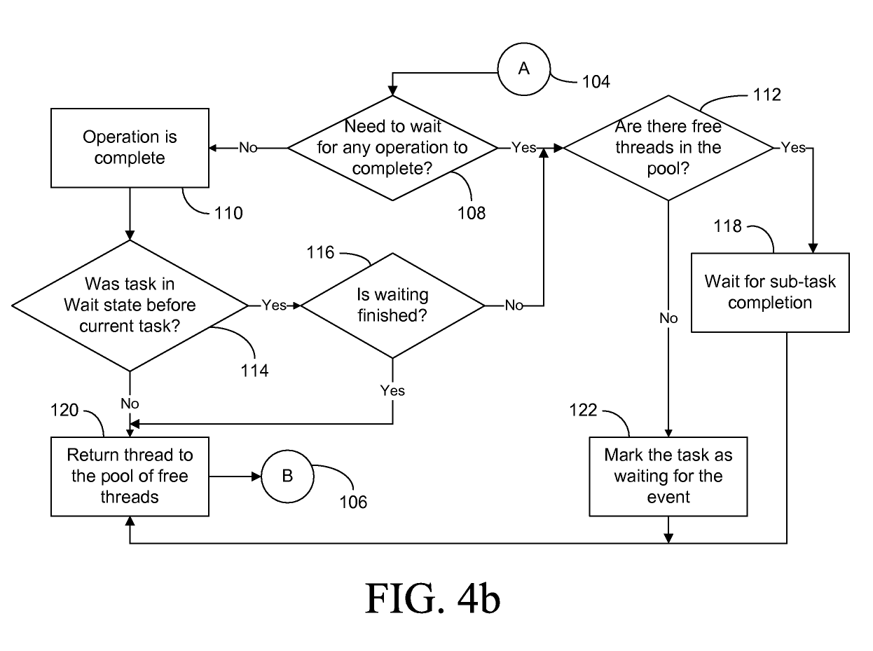

Referring now to FIGS. 4a and 4b a flowchart of a process for the hierarchical distribution and execution of tasks is shown. The following flow chart describes an embodiment of the invention. It illustrates the breaking of a task into smaller sub-tasks and the assigning of tasks to threads. Once a task is divided into smaller, hierarchically arranged tasks, it is assigned to a thread for processing. If a thread is unavailable, the current thread is used. A task that is dependent upon sub-tasks will wait for an event from each sub-task. When the final event is received, it is then processed by this task in either the thread of the final sub-task that issued the event or in a separate thread. We will now describe this process in detail with reference to FIGS. 4a and 4b.

Beginning at step 90 of FIG. 4a the process waits for a new task to arrive. At step 92 a test is made to determine if the task can be divided into subtasks. Tasks are defined by directives in the application placed there by the task developer. If this is the case processing moves to step 94 where the task is divided into sub-tasks. At step 96 a test is made to determine if a thread is available from a thread pool to execute the sub-task. If not processing moves to step 98 where the sub-task is executed in the current thread for the task. Step 92 also arrives at step 98 if the task cannot be divided into sub-tasks. If at step 96 a thread is available then processing moves to step 100 where the sub-task is executed in a free thread. Both steps 98 and 100 arrive at step 102 where a test is made to determine if there are more sub-tasks in the task. If this is the case processing returns to step 96. If not processing moves to FIG. 4b by transfer point 104. Transfer point 106 is the return from FIG. 4b to step 90.

Referring now to FIG. 4b processing continues at step 108 via transfer point 104. At step 108 a test is made to determine if any tasks or sub-tasks of the current thread remain to be completed. If all tasks and sub-tasks are completed processing moves to step 110 otherwise processing moves to step 112. Step 110 proceeds to step 114 where a test is made to determine if the current task was in a wait state, i.e. it was waiting for other tasks to complete. At step 112 a test is made to determine if there are any free threads in the thread pool. If so processing moves to step 118 where the process waits for completion of a sub-task and then moves to step 120. If not, processing moves to step 122. Returning to step 114 if a task was in a wait state before the current task, processing moves to step 116, otherwise to step 120. At step 116 a test is made to determine if the thread in a wait state has completed all tasks. If so, processing moves to step 120. If not processing returns to step 112. At step 120 processing moves to step 90 of FIG. 4a via transfer point 106. Returning to step 122 the task is configured as waiting for a sub-task to complete which is indicated by a sub-task sending an event to the parent task and processing moves to step 120.

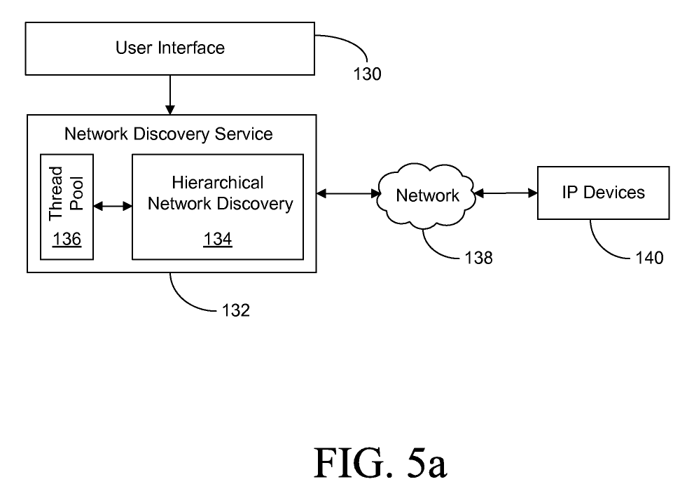

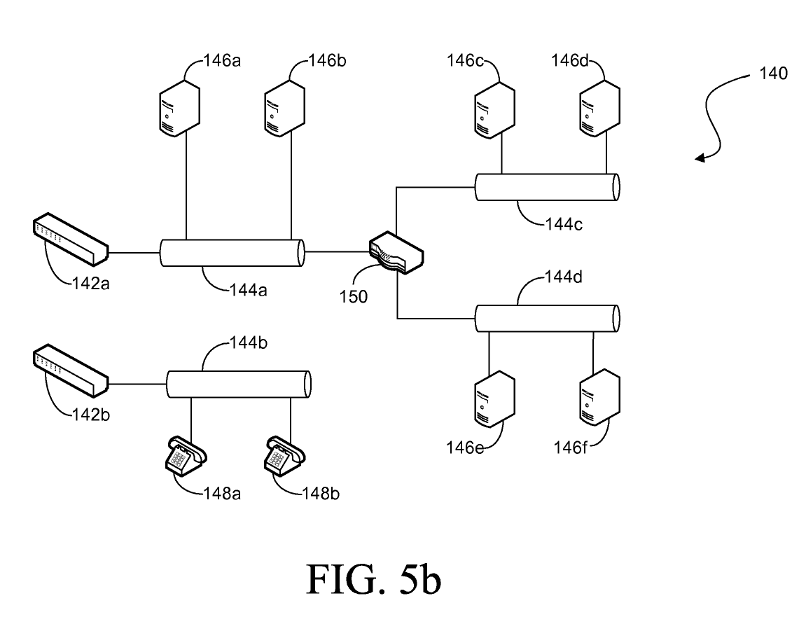

Referring now to FIGS. 5a and 5b a block diagram of a system utilizing an embodiment of the present invention is shown. FIGS. 5a and 5b illustrate the use of an embodiment of the present invention to enable the discovery of the IP addressees of devices connected to a network.

A user interface 130 allows a user to configure a network discovery process, for example the setting of IP addresses to discover, access to Windows Domain information or SNMP information. The information from user interface 130 is provided to a network discovery service 132 which may or may not be running on the same machine as the user interface 130. Network discovery service 132 comprises two main components, Hierarchical Network Discovery module 134 and thread pool 136. Module 134 is where an embodiment of the present invention exists, for example the one described in reference to FIGS. 4a and 4b and in which a hierarchical task structure is created to discover the network. Thread pool 136 consists of a pool of threads used to execute the tasks of module 134. In this example network discovery service 132 is capable of returning information on all devices that have an IP address and that responds to any of the discovery methods used, such as ping, Windows Domain and SNMP.

Network discovery service 132 is linked to a network 138 comprising a plurality of IP devices 140. Network 138 may be any network connected to IP devices 140, such as an Ethernet network. An example of a structure for feature 140 is shown in FIG. 5b.

Referring now to FIG. 5b, an example of the IP devices comprising feature 140 is shown. As one skilled in the art will appreciate, any number of IP devices may be resident in feature 140. As shown switch 142a is connected to an Ethernet network 144a, which comprises servers 146a and 146b. Similarly switch 142b is connected to Ethernet network 144b which comprises Voice over IP phones 148a and 148b. Feature 150 illustrates a router connected to Ethernet networks 144c and 144d. Ethernet network 144c comprises servers 146c and 146d. Network 144d comprises servers 146e and 146f.

The example shown in FIGS. 5a and 5b is intended to illustrate how an embodiment of the present invention may be utilized to discover all IP devices connected to a network. Although reference is made to Ethernet networks, any network connection IP devices may make use of the invention as disclosed herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In addition it is the intent of the inventor that the embodiments described herein may reside on a computer readable medium.

We claim:

1. A method of hierarchically dividing and executing a task on a computing device comprising the steps of:
a) dividing the task into a hierarchy of parent and sub-tasks;
b) associating the parent task or a sub-task to a thread, said thread obtained from a thread pool;
c) executing multiple sub-tasks within a parent thread if no additional threads are available in said thread pool; and
d) if said parent thread is waiting for one or more sub-tasks to complete, configuring said parent task to receive an event indicating the completion of sub-tasks associated with said parent task and returning the thread of said parent task to said thread pool for reuse.

2. The method of claim 1 wherein said method is utilized for network discovery, wherein the step of dividing a task into a hierarchy of sub-tasks comprises:
a) dividing the discovery of the network into sub-nets;
b) dividing a sub-net into individual IP addresses; and
c) utilizing multiple discovery methods for each IP address.

3. The method of claim 2 wherein the discovery methods are selected from the set comprising SNMP, Windows Domain and PING.

4. The method of claim 2 further comprising the step of collating the information from each discovery method and associating it with an IP address.

5. A method for hierarchically dividing and executing a task on a computing device comprising the steps of:
a) dividing the task into sub-tasks;
b) if a thread is available for a sub-task, utilizing said thread to execute said sub-task;
c) if a thread is not available for a sub-task running said sub-task in a parent thread;
d) if a task completes, returning said thread, associated with the task, to a thread pool for reuse; and
e) if a parent task is waiting for a sub-task to complete, configuring said parent task as waiting for an event to complete and returning the thread for said parent task to said thread pool for reuse.

6. The method of claim 5 wherein said method is utilized for network discovery, wherein the step of dividing a task into a hierarchy of sub-tasks comprises:
a) dividing the discovery of the network into sub-nets;
b) dividing a sub-net into individual IP addresses; and
c) utilizing multiple discovery methods for each IP address.

7. The method of claim 6 wherein the discovery methods are selected from the set comprising SNMP, Windows Domain and PING.

8. The method of claim 6 further comprising the step of collating the information from each discovery method and associating it with an IP address.

9. A system for hierarchically dividing and executing a task on a computing device comprising:
a) a user interface configured to permit a user to enter tasks to be executed;
b) a network discovery service operatively connected to said user interface and configured to receive input from said user interface;
c) a hierarchical module within said network discovery service configured to utilize a thread for a sub-task or a parent task;
d) said hierarchical module configured to obtain a thread for executing a sub-task or a parent task from a thread pool; and
e) said hierarchical module configured to return the thread of a parent task for reuse should said parent task be in a wait state and to configure said parent task as waiting for sub-tasks to complete.

10. The method of claim 1 embodied in a computer readable medium as instructions to be executed on a computing device.

11. The method of claim 5 embodied in a computer readable medium as instructions to be executed on a computing device.
